(19) United States
(12) Patent Application Publication
(10) Pub. No.: US 2026/0074865 A1
(43) Pub. Date: Mar. 12, 2026

(54) Block Acknowledgment Request as Initial Control Frame

(71) Applicant: Apple Inc., Cupertino, CA (US)

(72) Inventors: Neelakantan Nurani Krishnan, San Diego, CA (US); Abdel Karim Ajami, San Diego, CA (US); Anuj Batra, Redwood City, CA (US); Jarkko L. Kneckt, Los Gatos, CA (US); Qi Wang, Mountain View, CA (US); Yong Liu, Campbell, CA (US)

(21) Appl. No.: 19/304,111

(22) Filed: Aug. 19, 2025

Related U.S. Application Data
(60) Provisional application No. 63/692,591, filed on Sep. 9, 2024.

(51) Int. Cl. H04L 5/00; H04L 1/00; H04W 28/06; H04W 74/0808

(52) U.S. Cl. CPC H04L 5/0053; H04L 1/0008; H04W 28/06; H04W 74/0808

(57) ABSTRACT

An electronic device is described. This electronic device can include: an antenna node communicatively coupled to an antenna; and an interface circuit, communicatively coupled to the antenna node, that communicates with a second electronic device (such as a second access point). During operation, the interface circuit can generate, addressed to the second electronic device, a block acknowledgment request (BAR) frame that is configured as an initial control frame (ICF). Moreover, the BAR frame includes at least one of: padding for enhanced multi-link single radio (eMLSR); a length or duration of an immediate-control-response (ICR) to the BAR frame; or an indication of recommended feedback associated with the BAR frame.

### CROSS-REFERENCE TO RELATED APPLICATION

This application claims the benefit of U.S. Provisional Application No. 63/692,591, entitled “Block Acknowledgment Request as Initial Control Frame,” by Neelakantan Nurani Krishnan, et al., filed Sep. 9, 2024, the contents of which are hereby incorporated by reference.

### FIELD

The described embodiments relate, generally, to wireless communication among electronic devices, including using a block acknowledgment request (BAR) as an initial control frame.

### BACKGROUND

Many electronic devices communicate with each other using wireless local area networks (WLANs), such as those based on a communication protocol that is compatible with an Institute of Electrical and Electronics Engineers (IEEE) 802.11 standard (which is sometimes referred to as ‘Wi-Fi’).

In Wi-Fi communication, a station (STA) can dynamically indicate control information to a peer station. For example, the control information can include: imminent (upcoming) unavailability information (start time and duration), power state, low-latency data, and/or fast-link adaptation. Note that the peer station may (or may not) be an access point, and the station and the peer station may (or may not) be associated. Moreover, the unavailability can stem from in-device coexistence technologies (e.g., Bluetooth, ultra-wideband or UWB, etc.).

For example, a first station (STA 1, such as an access point or a non-access point station) can initiate a transmit opportunity (TXOP) with an initial-control-frame (ICF) and can solicit an immediate-control-response (ICR) from a second station (STA 2, such as a non-access point station or a mobile access point). The second station can include information about an upcoming unavailability period in the ICR. The purpose of unavailability signaling can be to prevent the first station from initiating new transmit opportunities when the second station is unavailable for Wi-Fi communication or activity.

However, the use ICF and ICR traffic can increase management overhead associated with communication on a shared channel, e.g., on one or more links between the first station and the second station.

### SUMMARY

An electronic device is described. This electronic device includes: an antenna node communicatively coupled to an antenna; and an interface circuit, communicatively coupled to the antenna node, that communicates with a second electronic device. During operation, the interface circuit provides or generates, addressed to the second electronic device, a block acknowledgment request (BAR) frame, where the BAR frame is an ICF. The BAR frame includes at least one of: padding for eMLSR operation; a length or duration of an ICR to the BAR frame; or an indication of recommended feedback associated with the BAR frame.

Moreover, the interface circuit can receive, associated with the second electronic device, a multi-station block acknowledgment (BA) (e.g., as the ICR) in response to the BAR frame.

Note that the BAR frame can include a single-user multi-traffic identifier (TID) BAR.

Furthermore, the BAR frame can include a compressed BAR frame that specifies a TID.

Additionally, a BAR control field in the BAR frame can include: an indication of whether the BAR frame is integrity protected; an indication of whether the BAR frame is the ICF; an indication of whether the second electronic device is to perform a carrier sense operation before providing the ICR; or an indication of whether the BAR frame includes second feedback to the second electronic device. Note that, when the indication of whether the BAR frame is the ICF indicates that the BAR frame is the ICF, the ICR in response to the BAR frame can be a multi-station BA. Alternatively, the indication as to whether the second electronic device is to perform a carrier sense operation before providing the ICR, and/or whether the BAR frame includes the second feedback to the second electronic device, can be valid when the BAR frame is the ICF.

In some embodiments, a BAR information field in the BAR frame can include: a bitmap indicating that the second feedback is included in the BAR frame.

Note that the BAR frame can include: an unavailability profile of the electronic device; or a power save attribute of the electronic device.

Moreover, the BAR frame can include: a packet number (PN) and a message integrity code (MIC) when the BAR frame is integrity protected; or a pre-padding frame check sequence (FCS) when the BAR frame is not integrity protected.

Furthermore, a BAR control field in the BAR frame can include multiple TIDs.

Additionally, the BAR frame can always be integrity protected.

In some embodiments, the BAR frame can always be an ICF.

Note that a BAR control field in the BAR frame can include: an indication of a key identifier; an indication of whether the second electronic device is to perform a carrier sense operation before providing the ICR; or an indication of whether the BAR frame includes second feedback to the second electronic device.

Moreover, the ICR in response to the BAR frame can always be a multi-station BA.

Other embodiments provide the second electronic device that performs counterpart operations to at least some of the operations performed by the electronic device. For example, the second electronic device can include: an antenna node communicatively coupled to an antenna; and an interface circuit, communicatively coupled to the antenna node, that communicates with the electronic device. During operation, the interface circuit receives, associated with the electronic device, a BAR frame, where the BAR frame is an CF, and where the BAR frame includes at least one of: padding for eMLSR operation; a length or duration of an ICR to the BAR frame; or an indication of recommended feedback associated with the BAR frame.

Note that the interface circuit can provide, addressed to the electronic device, a multi-station BA (e.g., as the ICR) in response to the BAR frame.

Other embodiments provide an integrated circuit (such as the interface circuit) for use with the electronic device or the second electronic device. The integrated circuit can perform at least some of the aforementioned operations of the electronic device or the second electronic device.

Other embodiments provide a computer-readable storage medium for use with the electronic device or the second electronic device. When program instructions stored in the computer-readable storage medium are executed by the electronic device or the second electronic device, the program instructions can cause the electronic device or the second electronic device to perform at least some of the aforementioned operations of the electronic device or the second electronic device.

Other embodiments provide a method. The method includes at least some of the aforementioned operations performed by the electronic device or the second electronic device.

This Summary is provided for purposes of illustrating some exemplary embodiments, so as to provide a basic understanding of some aspects of the subject matter described herein. Accordingly, it will be appreciated that the above-described features are only examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The included drawings are for illustrative purposes and serve only to provide examples of possible structures and arrangements for the disclosed systems and techniques for intelligently and efficiently managing communication between multiple associated user devices. These drawings in no way limit any changes in form and detail that can be made to the embodiments by one skilled in the art without departing from the spirit and scope of the embodiments. The embodiments will be readily understood by the following detailed description in conjunction with the accompanying drawings, where like reference numerals designate like structural elements.

FIG. 1 is a block diagram illustrating an example of communication between electronic devices.

FIG. 2 is a block diagram illustrating an example of communication between electronic devices.

FIG. 3 is a flow diagram illustrating an example method for providing or generating a block acknowledgment request (BAR) frame using an electronic device of FIG. 1 or 2.

FIG. 4 is a flow diagram illustrating an example method for receiving a BAR frame using an electronic device of FIG. 1 or 2.

FIGS. 5 and 6 are drawings illustrating examples of communication between the electronic devices of FIG. 1 or 2.

FIGS. 7 and 8 are drawings illustrating examples of a single-user multi-traffic identifier (TID) BAR frame as an initial control frame (ICF) according to some embodiments of the disclosure.

FIG. 9 is a drawing illustrating an example of a single-user compressed BAR frame as an ICF according to some embodiments of the disclosure.

FIG. 10 is a drawing illustrating an example of a BAR frame variant as an ICF according to some embodiments of the disclosure.

FIG. 11 illustrates an example of an electronic device of FIG. 1 according to some embodiments of the disclosure.

Note that like reference numerals refer to corresponding parts throughout the drawings. Moreover, multiple instances of the same part are designated by a common prefix separated from an instance number by a dash.

### DETAILED DESCRIPTION

An electronic device is described. This electronic device can include: an antenna node communicatively coupled to an antenna; and an interface circuit, communicatively coupled to the antenna node, that communicates with a second electronic device (such as a second access point). During operation, the interface circuit can generate, addressed to the second electronic device, a BAR frame configured as an initial control frame (ICF). Moreover, the BAR frame includes at least one of: padding for enhanced multi-link single radio (eMLSR) operation; a length or duration of an ICR to the BAR frame; or an indication of recommended feedback associated with the BAR frame.

By using a BAR frame as an ICF, these communication techniques can reduce management traffic overhead on a shared channel. For the BAR frame can convey information associated with an ICF. In these ways, the communication techniques can improve the user experience when using the electronic device or the second electronic device.

In the discussion that follows, a user can include: an individual, an organization, a company, a governmental agency, a for-profit business entity, a not-for-profit entity, or a group of one or more individuals.

Note that the communication techniques can be used during or with wired or wireless communication between electronic devices in accordance with a communication protocol, such as a communication protocol that is compatible with an IEEE 802.11 standard (which is sometimes referred to as Wi-Fi). However, the communication techniques can also be used with a wide variety of other communication protocols, and in electronic devices (such as portable electronic devices or mobile devices) that can incorporate multiple different radio access technologies (RATs) to provide connections through different wireless networks that offer different services and/or capabilities.

The electronic device and/or the second electronic device can include hardware and software to support a wireless personal area network (WPAN) according to a WPAN communication protocol, such as those standardized by the Bluetooth Special Interest Group and/or those developed by Apple (in Cupertino, California) that are referred to as an Apple Wireless Direct Link (AWDL). Moreover, the electronic device and/or the second electronic device can communicate via: a wireless wide area network (WWAN), a wireless metro area network (WMAN), a WLAN, near-field communication (NFC), a cellular-telephone or data network (such as using a third generation (3G) communication protocol, a fourth generation (4G) communication protocol, e.g., Long Term Evolution or LTE, LTE Advanced (LTE-A), a fifth generation (5G) communication protocol, or other present or future developed advanced cellular communication protocol) and/or another communication protocol. In some embodiments, the communication protocol includes a peer-to-peer communication technique.

The electronic device and/or the second electronic device, in some embodiments, can also operate as part of a wireless communication system, which can include a set of client devices, which can also be referred to as stations or client electronic devices, interconnected to an access point, e.g., as part of a WLAN, and/or to each other, e.g., as part of a WPAN and/or an ‘ad hoc’ wireless network, such as a Wi-Fi direct connection. In some embodiments, the client device can be any electronic device that is capable of communicating via a WLAN technology, e.g., in accordance with a WLAN communication protocol. Furthermore, in some embodiments, the WLAN technology can include a Wi-Fi (or more generically a WLAN) wireless communication subsystem or radio, and the Wi-Fi radio can implement an IEEE 802.11 technology, such as one or more of: IEEE 802.11a; IEEE 802.11b; IEEE 802.11g; IEEE 802.11-2007; IEEE 802.11n; IEEE 802.11-2012; IEEE 802.11-2016; IEEE 802.11ac; IEEE 802.11ax, IEEE 802.11ba, IEEE 802.11be, IEEE 802.11me, IEEE 802.11bn, IEEE 802.11bx, IEEE 802.11mf or other present or future developed IEEE 802.11 technologies.

Note that the electronic device and/or the second electronic device can use multi-user transmission (such as OFDMA) and/or multiple-input multiple-output (MIMO).

In some embodiments, the electronic device and/or the second electronic device can act as a communications hub that provides access to a WLAN and/or to a WWAN and, thus, to a wide variety of services that can be supported by various applications executing on the electronic device and/or the second electronic device. Thus, the electronic device and/or the second electronic device can include an ‘access point’ that communicates wirelessly with other electronic devices (such as using Wi-Fi), and that provides access to another network (such as the Internet) via IEEE 802.3 (which is sometimes referred to as ‘Ethernet’). Note that the access point can be a physical access point or a virtual or ‘software’ access point that is implemented on a computer or an electronic device. However, in other embodiments the electronic device and/or the second electronic device may not be an access point.

Additionally, it should be understood that the electronic devices described herein can be configured as multi-mode wireless communication devices that are also capable of communicating via different 3G and/or second generation (2G) RATs. In these scenarios, a multi-mode electronic device or UE can be configured to prefer attachment to LTE networks offering faster data rate throughput, as compared to other 3G legacy networks offering lower data rate throughputs. For example, in some implementations, a multi-mode electronic device is configured to fall back to a 3G legacy network, e.g., an Evolved High Speed Packet Access (HSPA+) network or a Code Division Multiple Access (CDMA) 2000 Evolution-Data Only (EV-DO) network, when LTE and LTE-A networks are otherwise unavailable. More generally, the electronic devices described herein can be capable of communicating with other present or future developed cellular-telephone technologies.

In accordance with various embodiments described herein, the terms ‘wireless communication device,’ ‘electronic device,’ ‘mobile device,’ ‘mobile station,’ ‘wireless station,’ ‘wireless access point,’ ‘station,’ ‘access point’ and ‘user equipment’ (UE) can be used herein to describe one or more consumer electronic devices that can be capable of performing procedures associated with various embodiments of the disclosure.

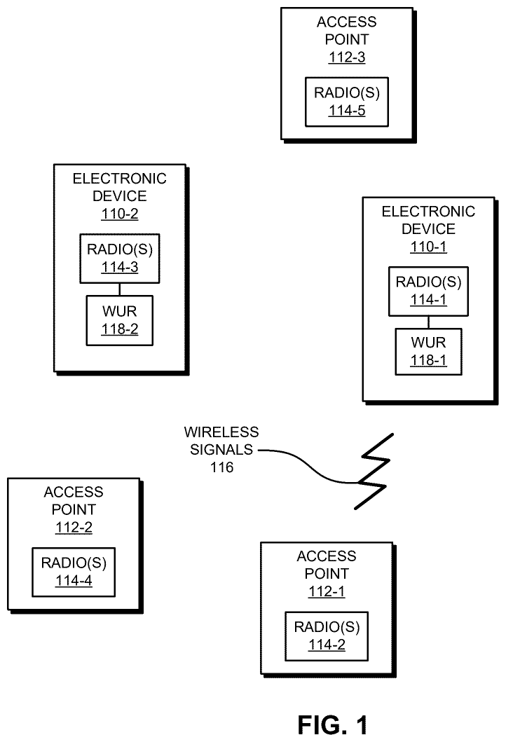

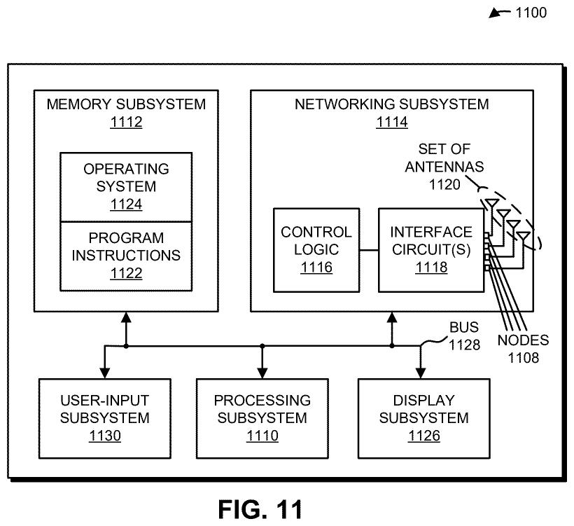

FIG. 1 presents a block diagram illustrating an example of electronic devices communicating wirelessly. Notably, one or more electronic devices 110 (such as a smartphone, a laptop computer, a notebook computer, a tablet, or another such electronic device) and access point 112-1 can communicate wirelessly in a WLAN using an IEEE 802.11 communication protocol. Thus, electronic devices 110 can be associated with or can have one or more connections with access point 112-1. For example, electronic devices 110 and access point 112-1 can wirelessly communicate while: detecting one another by scanning wireless channels, transmitting and receiving beacons or (equivalently) beacon frames on wireless channels, establishing connections (for example, by transmitting connect requests), and/or transmitting and receiving packets or frames (which can include the request and/or additional information, such as data, as payloads). Note that access point 112-1 can provide access to a network, such as the Internet, via an Ethernet protocol, and can be a physical access point or a virtual or ‘software’ access point that is implemented on a computer or an electronic device. In the discussion that follows, electronic devices 110 are sometimes referred to as ‘clients,’ ‘stations,’ or ‘recipient electronic devices.’ As described further below with reference to FIG. 11, electronic devices 110 and access point 112-1 can include subsystems, such as a networking subsystem, a memory subsystem, and a processor subsystem. In addition, electronic devices 110 and access point 112-1 can include radios 114 in the networking subsystems. More generally, electronic devices 110 and access point 112-1 can include (or can be included within) any electronic devices with networking subsystems that enable electronic devices 110 and access point 112-1, respectively, to wirelessly communicate with another electronic device. This can include transmitting beacon frames on wireless channels to enable the electronic devices to make initial contact with or to detect each other, followed by exchanging subsequent data/management frames (such as connect requests) to establish a connection, configure security options (e.g., IPSec), transmit and receive packets or frames via the connection, etc.

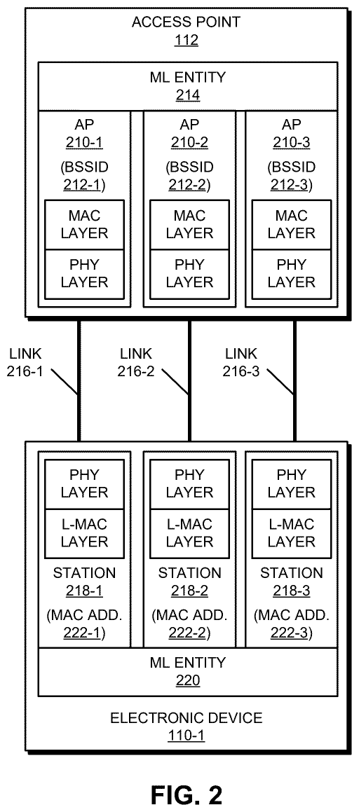

As can be seen in FIG. 1, wireless signals 116 (represented by a jagged line) are communicated by one or more radios 114-1 and 114-2 in electronic device 110-1 and access point 112-1, respectively. For example, as noted previously, electronic device 110-1 and access point 112-1 can exchange packets or frames using a Wi-Fi communication protocol in a WLAN. As illustrated further below with reference to FIGS. 2-22, one or more radios 114-1 can receive wireless signals 116 that are transmitted by one or more radios 114-2 via one or more links between electronic device 110-1 and access point 112-1. Alternatively, the one or more radios 114-1 can transmit wireless signals 116 that are received by the one or more radios 114-2.

In some embodiments, wireless signals 116 are communicated by one or more radios 114 in electronic devices 110 and access point 112-1, respectively. For example, one or more radios 114-1 and 114-3 can receive wireless signals 116 that are transmitted by one or more radios 114-2 via one or more links between electronic devices 110-1 and 110-2, and access point 112-1.

Note that the one or more radios 114-1 can consume additional power in a higher-power mode. If the one or more radios 114-1 remain in the higher-power mode even when they are not transmitting or receiving packets or frames, the power consumption of electronic device 110-1 can be needlessly increased. Consequently, electronic devices 110 can include wake-up radios (WURs) 118 that listen for and/or receive wake-up frames (and/or other wake-up communications), e.g., from access point 112-1. When a particular electronic device (such as electronic device 110-1) receives a wake-up frame, WUR 118-1 can selectively wake-up radio 114-1, e.g., by providing a wake-up signal that selectively transitions at least one of the one or more radios 114-1 from a lower-power mode to the higher-power mode.

IEEE 802.11be has proposed the use of multiple concurrent links between electronic devices, such as access point 112-1 and one or more of electronic device 110. For example, as shown in FIG. 2, which presents a block diagram illustrating an example of electronic devices communicating wirelessly, access point 112-1 can be an access point multi-link device (MLD) that includes multiple access points 210, which are cohosted or collocated in access point 112-1. In the present discussion, ‘cohosted’ or ‘collocated’ means that access points 210 are physically or virtually implemented in the same access point MLD, or are affiliated with the same access point MLD. Note that this meaning of ‘cohosted’ does not indicate that access points 210 have the same primary 20 MHz channel. Access points 210 can have associated BSSIDs 212, and media access control (MAC) and physical (PHY) layers (including separate radios, which can be included in the same or different integrated circuits). Note that access point 112-1 can have an ML entity 214 having an MLD MAC address, an ML identifier, a service set identifier (SSID), and that can provide security for access points 210.

Moreover, access points 210 can have different concurrent links 216 in different bands of frequencies (such as a link 216-1 with a link identifier 1 in a 2.4 GHz band of frequencies, a link 216-2 with a link identifier 2 in a 5 GHz band of frequencies and a link 216-3 with a link identifier 3 in a 6 GHz bands of frequencies) with stations 218 in at least electronic device 110-1, which is a non-access point MLD. These stations can have associated lower MAC and PHY layers (including separate radios, which can be included in the same or different integrated circuits). In addition, electronic device 110-1 can have an ML entity 220 having an MLD MAC address.

For example, the access point MLD can have three radios. One radio can operate on a 2.4 GHz band of frequencies, and the other radios can operate on the ⅚ GHz bands of frequencies. The access point MLD can create three access points 210, operating on a 2.4 GHz channel, a 5 GHz channel, and a 6 GHz channel respectively. The three access points 210 can operate independently, each of which has at least one BSS with different BSSIDs 212. (While FIG. 2 illustrates the access point MLD with three access points 210, more generally the access point MLD can include up to 15 access points with one or more access points in a given band of frequencies.) Moreover, each of the access points 210 can accommodate both legacy non-access point stations as well as non-access point MLD stations 218. Furthermore, each of access points 210 can transmit its own beacon frames using its own BSSID. Additionally, the access point MLD can have ML entity 214, identified by an MLD address (such as an MLD MAC address). This MAC address can be used to pair with ML entity 220 of the associated non-access point MLD stations 218.

Moreover, the non-access point MLD station (e.g., electronic device 110-1) can have two or three radios. One radio can operate on a 2.4 GHz band of frequencies, and the other radios can operate on the ⅚ GHz bands of frequencies. When the non-access point MLD establishes an ML association with the access point MLD, it can create up to three stations 218, each of which associates to one of access points 210 within the access point MLD. Each of stations 218 can have a different OTA MAC address 222. The non-access point MLD can also have ML entity 220, identified by another MLD address (such as another MLD MAC address). This MLD MAC address can be used to pair with ML entity 214 of the associated access point MLD.

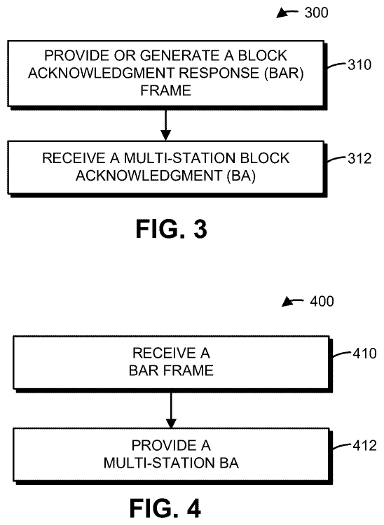

Referring back to FIG. 1, as noted previously, communication of an ICF and/or an ICR can increase management traffic overhead on a shared channel. In order to address these problems, as described further below with reference to FIGS. 3-10, in the communication techniques stations (such as electronic devices 110-1 and 110-2) can perform the communication techniques.

Notably, electronic device 1110-1 can provide or generate, addressed to electronic device 110-2, a BAR frame, where the BAR frame is an ICF. The BAR frame can include at least one of: padding for eMLSR operation; a length or duration of an ICR to the BAR frame; or an indication of recommended feedback associated with the BAR frame. This BAR frame can be received by electronic device 110-2.

Then, as a response to the BAR frame, electronic device 110-2 can provide, addressed to electronic device 110-1, a multi-station BA. This multi-station BA can be received by electronic device 110-1. Note that the multi-station BA can be an ICR in response to the BAR frame.

Note that the BAR frame can include a single-user multi-TID BAR.

Furthermore, the BAR frame can include a compressed BAR frame that specifies a TID.

Additionally, a BAR control field in the BAR frame can include: an indication of whether the BAR frame is integrity protected; an indication of whether the BAR frame is the ICF; an indication of whether electronic device 110-2 is to perform a carrier sense operation before providing the ICR; or an indication of whether the BAR frame includes second feedback to electronic device 110-2. Note that, when the indication of whether the BAR frame is the ICF indicates that the BAR frame is the ICF, the ICR in response to the BAR frame can be a multi-station BA. Alternatively, the indication as to whether electronic device 110-2 is to perform a carrier sense operation before providing the ICR, and/or whether the BAR frame includes the second feedback to electronic device 110-2, can be valid when the BAR frame is the ICF.

In some embodiments, a BAR information field in the BAR frame can include: a bitmap indicating that the second feedback is included in the BAR frame.

Note that the BAR frame can include: an unavailability profile of electronic device 110-1; or a power save attribute of electronic device 110-1.

Moreover, the BAR frame can include: a PN and a MIC when the BAR frame is integrity protected; or a pre-padding FCS when the BAR frame is not integrity protected.

Furthermore, a BAR control field in the BAR frame can include multiple TIDs.

Additionally, the BAR frame can always be integrity protected.

In some embodiments, the BAR frame can always be an ICF.

Note that a BAR control field in the BAR frame can include: an indication of a key identifier; an indication of whether electronic device 110-2 is to perform a carrier sense operation before providing the ICR; or an indication of whether the BAR frame includes second feedback to electronic device 110-2.

Moreover, the ICR in response to the BAR frame can always be a multi-station BA.

In summary, the disclosed communication techniques can facilitate improved performance of electronic devices 110. For example, using the communication techniques, electronic device 110-1 can communicate an ICF using a BAR frame. In these ways, the communication techniques can improve the user experience when using electronic devices 110-1 and/or 110-2.

While the preceding discussion illustrated communication by electronic device 110-1, in other embodiments the roles of electronic device 110-1 and electronic device 110-2 can be reversed in the communication techniques. Alternatively, in some embodiments, the communication techniques are performed between access point 112-1 and access point 112-2 or one of electronic devices 110. Thus, the communication techniques can be performed between: at least a pair of access points; at least a pair of stations; or an access point and at least a station.

Note that access point 112-1 and one or more electronic devices (such as electronic devices 110-1 and/or 110-2) can be compatible with an IEEE 802.11 standard that includes trigger-based channel access (such as IEEE 802.11ax). However, access point 112-1 and the one or more electronic devices can also communicate with one or more legacy electronic devices that are not compatible with the IEEE 802.11 standard (i.e., that do not use multi-user trigger-based channel access). In some embodiments, access point 112-1 and the one or more electronic devices use multi-user transmission (such as OFDMA). For example, the one or more radios 114-2 can provide one or more trigger frames for the one or more electronic devices. Moreover, in response to receiving the one or more trigger frames, the one or more radios 114-1 can provide one or more group or block acknowledgments to the one or more radios 114-2. For example, the one or more radios 114-1 can provide the one or more group acknowledgments during associated assigned time slot(s) and/or in an assigned channel(s) in the one or more group acknowledgments. However, in some embodiments one or more of electronic devices 110 can individually provide acknowledgments to the one or more radios 114-2. Thus, the one or more radios 114-1 (and, more generally, radios 114 in the electronic devices 110-1 and/or 110-2) can provide one or more acknowledgments to the one or more radios 114-2.

In the described embodiments, processing a packet or frame in one of electronic devices 110 and access point 112-1 includes: receiving wireless signals 116 encoding a packet or a frame; decoding/extracting the packet or frame from received wireless signals 116 to acquire the packet or frame; and processing the packet or frame to determine information contained in the packet or frame (such as data in the payload).

In general, the communication via the WLAN in the communication techniques can be characterized by a variety of communication-performance metrics. For example, the communication-performance metric can include one or more of: an RSSI, a data rate, a data rate for successful communication (which is sometimes referred to as a ‘throughput’), a latency, an error rate (such as a retry or resend rate), a mean-square error of equalized signals relative to an equalization target, inter-symbol interference, multipath interference, a signal-to-noise ratio (SNR), a width of an eye pattern, a ratio of a number of bytes successfully communicated during a predetermined or predefined time interval (such as a time interval between, e.g., 1 and 10 s) to an estimated maximum number of bytes that can be communicated in the predetermined or predefined time interval (the latter of which is sometimes referred to as the ‘capacity’ of a communication channel or link), and/or a ratio of an actual data rate to an estimated data rate (which is sometimes referred to as ‘utilization’).

Although we describe the network environment shown in FIG. 1 as an example, in alternative embodiments, different numbers and/or types of electronic devices can be present. For example, some embodiments can include more or fewer electronic devices. As another example, in other embodiments, different electronic devices can be transmitting and/or receiving packets or frames. In some embodiments, multiple links can be used during communication between electronic devices 110. Consequently, one of electronic devices 110 can perform operations in the communication techniques.

FIG. 3 presents a flow diagram illustrating an example method 300 for providing or generating a BAR frame. This method can be performed by an electronic device, such as electronic device 110-1 in FIG. 1. For example, method 300 can be implemented by an interface circuit in electronic device 110-1 in FIG. 1. Note that the communication between the electronic device and a second electronic device (such as electronic device 110-2 in FIG. 1) can be compatible with an IEEE 802.11 communication protocol.

During operation, the electronic device can provide or generate, addressed to the second electronic device, a BAR frame (operation 310), where the BAR frame is an ICF. The BAR frame includes at least one of: padding for eMLSR operation; a length or duration of an ICR to the BAR frame; or an indication of recommended feedback associated with the BAR frame. Then, the electronic device can receive, associated with the second electronic device, a multi-station BA (operation 312) (e.g., as the ICR) in response to the BAR frame.

Note that the BAR frame can include a single-user multi-TID BAR.

Furthermore, the BAR frame can include a compressed BAR frame that specifies a TID.

Additionally, a BAR control field in the BAR frame can include: an indication of whether the BAR frame is integrity protected; an indication of whether the BAR frame is the ICF; an indication of whether the second electronic device is to perform a carrier sense operation before providing the ICR; or an indication of whether the BAR frame includes second feedback to the second electronic device. Note that, when the indication of whether the BAR frame is the ICF indicates that the BAR frame is the ICF, the ICR in response to the BAR frame can be a multi-station BA. Alternatively, the indication as to whether the second electronic device is to perform a carrier sense operation before providing the ICR, and/or whether the BAR frame includes the second feedback to the second electronic device, can be valid when the BAR frame is the ICF.

In some embodiments, a BAR information field in the BAR frame can include: a bitmap indicating that the second feedback is included in the BAR frame.

Note that the BAR frame can include: an unavailability profile of the electronic device; or a power save attribute of the electronic device.

Moreover, the BAR frame can include: a PN and a MIC when the BAR frame is integrity protected; or a pre-padding FCS when the BAR frame is not integrity protected.

Furthermore, a BAR control field in the BAR frame can include multiple TIDs.

Additionally, the BAR frame can always be integrity protected.

In some embodiments, the BAR frame can always be an ICF.

Note that a BAR control field in the BAR frame can include: an indication of a key identifier; an indication of whether the second electronic device is to perform a carrier sense operation before providing the ICR; or an indication of whether the BAR frame includes second feedback to the second electronic device.

Moreover, the ICR in response to the BAR frame can always be a multi-station BA.

FIG. 4 presents a flow diagram illustrating an example method 400 for receiving a BAR frame. This method can be performed by a second electronic device, such as electronic device 110-2 in FIG. 1. For example, method 300 can be implemented by an interface circuit in electronic device 110-2 in FIG. 1. Note that the communication between the second electronic device and an electronic device (such as electronic device 110-1 in FIG. 1) can be compatible with an IEEE 802.11 communication protocol.

During operation, the second electronic device can receive, associated with an electronic device, a BAR frame (operation 410), where the BAR frame is an CF, and where the BAR frame includes at least one of: padding for eMLSR operation; a length or duration of an ICR to the BAR frame; or an indication of recommended feedback associated with the BAR frame. Then, the second electronic device can provide, addressed to the electronic device, a multi-station BA (operation 412) (e.g., as the ICR) in response to the BAR frame.

In some embodiments of methods 300 (FIG. 3) and/or 400, there can be additional or fewer operations. Further, one or more different operations can be included. Moreover, the order of the operations can be changed, and/or two or more operations can be combined into a single operation or performed at least partially in parallel.

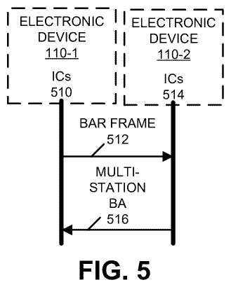

The communication techniques are further illustrated in FIG. 5, which presents a flow diagram illustrating an example of communication between electronic devices 110-1 and 110-2. During operation, one or more interface circuits (or interface circuitry) 510 in electronic device 110-1 can provide or generate, addressed to electronic device 110-2, a BAR frame 512, where the BAR frame is an ICF. The BAR frame includes at least one of: padding for eMLSR operation; a length or duration of an ICR to the BAR frame; or an indication of recommended feedback associated with the BAR frame. This BAR frame can be received by one or more interface circuits (or interface circuitry) 514 in electronic device 110-2.

In response to BAR fame 512, the one or more interface circuits 514 can provide, addressed to electronic device 110-1, a multi-station BA 516. This multi-station BA can be received by the one or more interface circuit 510. Note that multi-station BA 516 can be an ICR in response to BAR frame 512.

While communication between the components in FIG. 5 is illustrated with unilateral or bilateral communication (e.g., lines having a single arrow or dual arrows), in general a given communication operation can be unilateral or bilateral. Moreover, while operations in FIG. 5 are illustrated as being sequential, in some embodiments at least some of the operations can be performed in parallel.

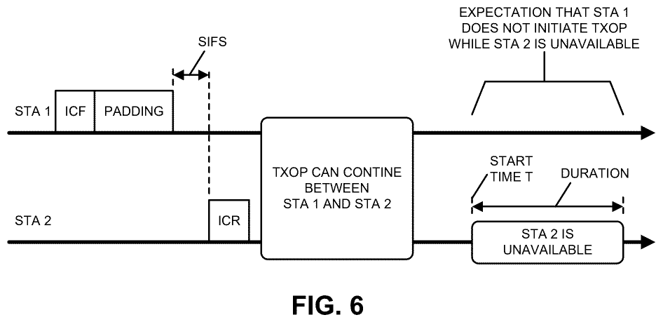

We now further describe embodiments of the disclosed communication techniques. As discussed previously, a station can dynamically indicate control information to a peer station. For example, as shown in FIG. 6, which presents a drawing illustrating an example of communication between the electronic devices of FIGS. 1 or 2, a first station (STA 1, such as an access point or a non-access point station) can initiate a transmit opportunity (TXOP) with an ICF and can solicit an ICR from a second station (STA 2, such as a non-access point station or a mobile access point). The second station can include information about an upcoming unavailability period in the ICR. The purpose of unavailability signaling is to prevent the first station from initiating new transmit opportunities when the second station is unavailable for Wi-Fi communication or activity.

Note that ‘ICF’ in ultra-high reliability (UHR) has a larger scope compared to extremely high throughput (EHT). In EHT, an ICF (such as a multi-user request-to-send (MU-RTS) or a buffer status report poll (BSRP) can be to indicate via the link of a downlink (DL) transmit opportunity in case of eMLSR operation. (While IEEE 802.11be allows stations to simultaneously operate on multiple links using multiple radios in a higher-power mode, this can be expensive in terms of power consumption. Instead, a station can have one or more radios in an eMLSR mode. This can allow lower-power listening or monitoring until a radio in a higher-power mode is needed on a given link.) Note that the ICR can confirm that the link switch has been completed.

In addition to the preceding functionality, in UHR the ICF and ICR can carry or convey control feedback information between the transmit-opportunity initiator and responder. Note that in addition to unavailability information, other control feedback can also be included in the ICR by the second station. For example, the other control feedback can include: power-save parameters, presence of low-latency traffic, attributes for fast link adaptation, etc.

In the disclosed communication techniques, a BAR can be modified to function as an ICF. Notably, one or more candidate BAR frames for single-user (SU) ICF for downlink and uplink or UL (e.g., a UHR access point communicating with a UHR station) can include: a multi-TID BAR; a compressed and/or an extended compressed BAR (in which the response is a multi-station BA); and/or a BAR frame variant. Note that the desired ICR response can be a multi-station block acknowledgment (BA) in non-high throughput (HT) (dup or duplicate) format (which can duplicate a 20 MHz transmission in multiple adjacent 20 MHz channels).

Note that existing BARs support some of the features that can enable its use as a single-user ICF. Notably, existing BARs can include capabilities, such as: a response type of a multi-station BA in response to a multi-TID BAR; a response format is a non-high throughput (dup); a non-access point station currently allowed to send an ICF; transmit-opportunity protection from legacy stations (note that both ICF and ICR can be non-high throughput); and a low frame overhead (e.g., a BAR control can be approximately 4 μs at 6 Mbps). Moreover, in the discussed communication techniques, the BAR can be modified to support padding for eMLSR operation; add signaling to control the ICR length and/or duration; and/or provide support for UHR eMLSR operation.

Furthermore, in the disclosed communication techniques: the ICF can allow a transmit-opportunity initiator to indicate preferred feedback from a transmit-opportunity responder; the ICF can allow the transmit-opportunity initiator to include special control feedback to the transmit-opportunity responder; and/or the receiver of ICF can readily or easily identify the different feedback information included in the ICF.

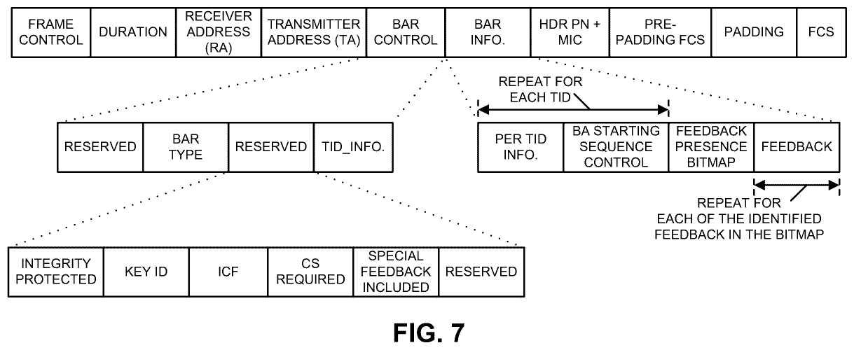

FIG. 7 presents a drawing illustrating an example of a single-user multi-TID BAR frame as an ICF in the disclosed communication techniques. Notably, the BAR control can include a reserved bit. Then the BAR control can include the BAR type (e.g., four bits), which can indicate that the BAR is a multi-TID BAR (e.g., using a value of ‘3’). Moreover, reserved bits (e.g., 7 bits) in the BAR control can indicate: integrity protected (e.g., using 1 bit, which can be set to ‘1’ to indicate that the frame is integrity protected), a key identifier or ID (e.g., using 1 bit, which can be ‘0’ or ‘1’), an initial control frame or ICF (e.g., using 1 bit, which can be set to ‘1’ to indicate that the frame acts as an ICF), carrier sense (CS) required (e.g., using 1 bit, which can be set to ‘1’ to indicate that the recipient station can perform a CS check to see if the medium is in use before responding to the ICF when the initial control frame bit is set to ‘1’), special feedback included (e.g., using 1 bit, which can be set to ‘1’ to indicate that special control feedback is included in the ICF when the initial control frame bit is set to ‘1’), and/or reserved bits (e.g., 2 bits). Note that the TID information or TID_INFO (e.g., four bits) in the BAR control can be set to ‘1111’ when a legacy BA is not solicited by the ICF from the recipient station; or, when a legacy BA is required from the recipient station, the baseline rules can be followed (such as the TID_INFO can equal a number of TIDs present in the BAR information).

Furthermore, the BAR information can have a variable length and can include special feedback when the special feedback included bit is set to ‘1’. The special feedback can include: a feedback presence bitmap (e.g., 2 octets) and/or feedback (e.g., having a variable length). For example, the feedback can be repeated for each identified feedback in the feedback presence bitmap. In embodiments where the BAR is a legacy BAR (e.g., when the TID_INFO=‘1111’), the BAR information can also include: per TID info., and a BA starting sequence control. The per TID info. and the BA starting sequence control can be repeated for each TID, where the number of TIDs equals the TID_info. plus one.

The single-user multi-TID BAR frame can include: a high data rate (HDR) PN and a MIC (which can be present when the integrity protected bit equals, e.g., ‘1’, and can have a length of 20 bytes); a pre-padding frame check sequence or FCS (which can be present when the integrity protected bit equals, e.g., ‘0’); and/or padding (which can have a variable length and can be present when the initial control frame bit equals, e.g., ‘1’). The presence of the HDR PN and the MIC can indicate that the single-user multi-TID BAR frame is integrity protected. In some embodiments, the single-user multi-TID BAR frame can include either the HDR PN and the MIC or the pre-padding FCS.

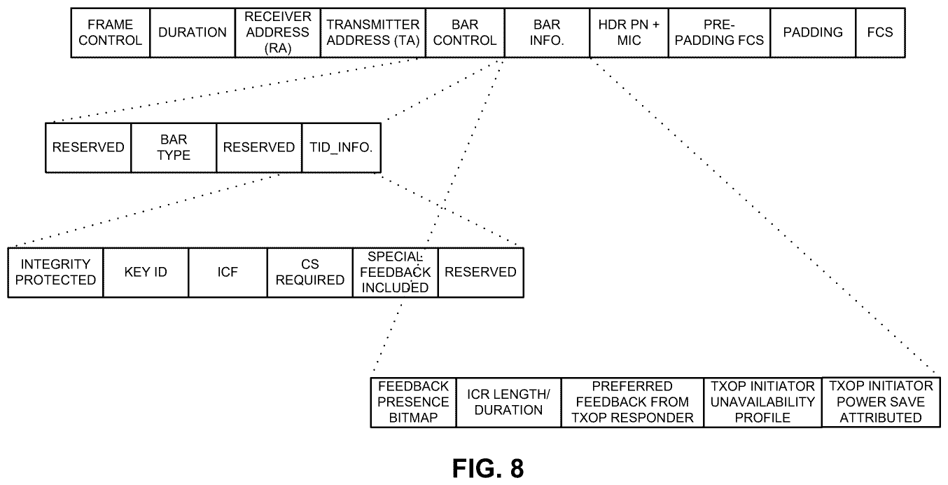

Additionally, FIG. 8 presents a drawing illustrating an example of a single-user multi-TID BAR frame as an ICF. Notably, the BAR type can indicate that the BAR is a multi-TID BAR (e.g., using a value of ‘3’). Moreover, reserved bits (e.g., 7 bits) in the BAR control can indicate: integrity protected (e.g., using 1 bit), a key identifier (e.g., using 1 bit), an initial control frame (e.g., using 1 bit, which can be set to ‘1’ to indicate that the frame acts as an ICF), CS required (e.g., using 1 bit) and/or special feedback included (e.g., using 1 bit). Furthermore, the BAR information can include: a feedback presence bitmap (e.g., using two octets), an ICR length/duration (e.g., using one octet), preferred feedback from a transmit-opportunity (TXOP) responder (e.g., using two octets), a transmit-opportunity unavailability profile (e.g., using six octets), and/or transmit-opportunity power save attributes (e.g., using two octets). The ICR length/duration and the preferred feedback from a transmit-opportunity responder can be DC control information that is required uplink information that is to be received from the transmit-opportunity responder, while the transmit-opportunity unavailability profile and the transmit-opportunity power save attributes can be sent to the transmit-opportunity responder. Note that bits in the feedback presence bit map can be set to ‘1’ to identify the special feedback information included as part of the ICT. For example, the feedback presence bit map can include ‘0×8 0000 1111,’ where the last four 1 s, respectively, indicate the presence of the ICR length/duration, the preferred feedback from a transmit-opportunity responder, the transmit-opportunity unavailability profile, and the transmit-opportunity power save attributes. Additionally, the preferred feedback from a transmit-opportunity responder can include the unavailability profile and the presence of low-latency traffic, such as ‘0×8 0001 0100.’ In some embodiments, the single-user multi-TID BAR frame can include HDR PN and MIC, and padding.

In some embodiments of the BAR information field, bit positions in the feedback presence bitmap can indicate the information in the feedback subfield. For example, for feedback information requested from a transmit-opportunity responder: bit 0 (B0) can indicate a length/duration of the ICR response from the transmit-opportunity responder (such as using one octet); and bit 1 (B1) can indicate a bitmap indicating preferred feedback from the transmit-opportunity responder (such as using two octets). Moreover, for feedback information provided to the transmit-opportunity responder by the transmit-opportunity initiator: bit 2 (B2) can indicate control feedback of a coexistence unavailability profile from the transmit-opportunity initiator (such as using six octets); bit 3 (B3) can indicate control feedback of power-save parameters (such as bandwidth or BW, a modulation coding scheme or MCS, and/or a number of spatial streams or NSS) from the transmit-opportunity initiator (such as using two octets); bit 4 (B4) can indicate control feedback of low-latency traffic presence from the transmit-opportunity initiator (such as using two octets); bit 5 (B5) can indicate control feedback of fast link adaptation from the transmit-opportunity initiator (such as using six octets); other values can indicated unused/reserved bits.

Note that when B1 is ‘1’, the transmit-opportunity initiator can indicate preferred feedback from the transmit-opportunity responder by setting bit in a bitmap. This can be a recommendation. The transmit-opportunity responder can have autonomy to include any feedback in an ICR while ensuring length/duration of the IDR is as indicated by the transmit-opportunity initiator. In some embodiments, the feedback subfield can be ‘0×8 00001100.’ This can indicate that the transmit-opportunity initiator can prefer the following information from the transmit-opportunity responder: coexistence (CoEx) unavailability profiles; and power-save parameters.

In some embodiments, the bit positions in the feedback subfield can include or indicate: a coexistence unavailability profile using B2; power-save parameters using B3; low-latency traffic using B4; fast link adaptation parameters using B5; and B6-B15 can be unused/reserved.

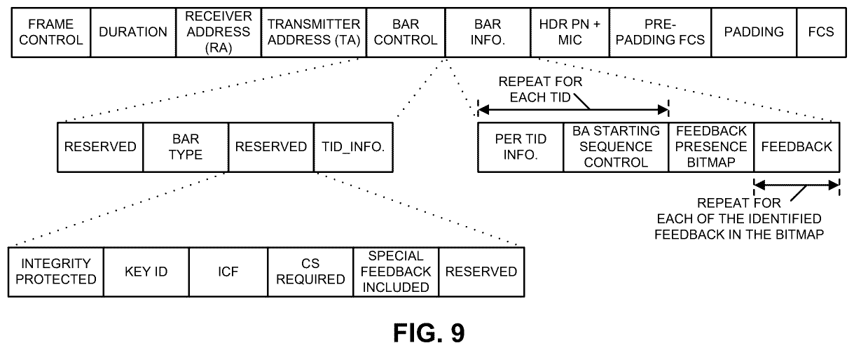

Moreover, FIG. 9 presents a drawing illustrating an example of a single-user (extended) compressed BAR frame as an ICF. The single-user compressed BAR frame can specify a particular TID (as opposed to being multi-TID). In the compressed BAR frame, reserved bits (e.g., 7 bits) in the BAR control can indicate: integrity protected (e.g., using 1 bit), a key identifier (e.g., using 1 bit), an initial control frame (e.g., using 1 bit, which can be set to ‘1’ to indicate that the frame acts as an ICF; and, when this bit is set to ‘1’, then the response can be a multi-station BA; otherwise, the response can be a BA, as opposed to a multi-station BA), CS required (e.g., using 1 bit, which can be set to ‘1’ to indicate that the recipient station should perform a CS check before responding, when the initial control frame bit is ‘1’) and/or special feedback included (e.g., using 1 bit, which can be set to ‘1 to indicate that special control feedback is included in the ICF, when the initial control frame bit is ‘1’). Note that the TID information (TID_INFO) in the BAR control can be set to ‘1111’ when a legacy BA is not solicited by the ICF from the transmit-opportunity responder; or, when a legacy BA is required from the transmit-opportunity responder, the baseline rules can be followed (such as the TID_INFO can equal the TID or TIDs for which a BA is requested). Furthermore, the BAR information can include: a feedback presence bitmap (e.g., using two octets), and/or feedback (e.g., having a variable length). Note that the special feedback (including the feedback presence bitmap and/or the feedback) can be present when the special feedback included bit is ‘1’. The feedback can be repeated for each identified feedback in the feedback presence bitmap. In embodiments where the BAR is a legacy BAR (e.g., when the TID_INFO=‘1111’), the BAR information can include: per TID information and/or block acknowledgement starting sequence control. The per TID information and/or the block acknowledgement starting sequence control can be repeated for each TID (the number of TIDs equal to the TID_INFO plus one.

Additionally, the single-user compressed BAR frame can include: an HDR PN and a MIC (which can be present when the integrity protected bit equals, e.g., ‘1’, and can have a length of 20 bytes); a pre-padding FCS (which can be present when the integrity protected bit equals, e.g., ‘0’); and/or padding (which can have a variable length and can be present when the initial control frame bit equals, e.g., ‘1’).

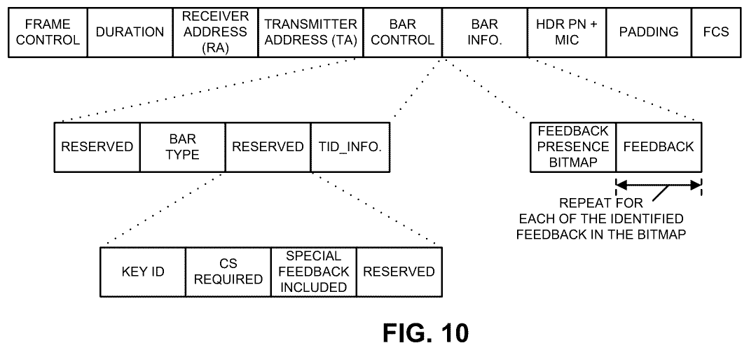

FIG. 10 presents a drawing illustrating an example of a BAR frame variant as an ICF. This BAR frame variant can act as an ICF because it can be exchanged between UHR stations. The BAR frame variant can be integrity protected and can solicit a multi-station (M-STA) BA (in non-high throughput format) as a response. Moreover, the BAR frame variant can act as an ICF (and, thus, it may not solicit a legacy BA as a response).

Notably, the BAR frame can include: BAR control, BAR information (e.g., having a variable length), HDR PN and MIC (e.g., 20 octets), and/or padding (e.g., having variable length). The BAR type in the BAR control can be set to a reserved value to indicate a BAR frame variant (e.g., using one or more of four bits). Moreover, reserved bits (e.g., 7 bits) in the BAR control can indicate: a key identifier (e.g., using 1 bit), CS required (e.g., using 1 bit), special feedback included (e.g., using 1 bit), and/or reserved (e.g., 4 bits). Furthermore, the BAR information can include: a feedback presence bitmap (e.g., using two octets), and/or feedback (e.g., having a variable length). Note that the feedback can be repeated for each of the identified feedback in the feedback presence bitmap.

In summary, the aforementioned communication techniques disclose how a BAR frame can be repurposed as a single-user ICF. Note that the disclosed embodiments can include: a multi-TID BAR, a compressed (extended) BAR), and/or a BAR frame variant.

In some embodiments, the communication techniques can be implemented in a physical layer and/or a MAC layer.

Note that the formats of packets or frames communicated during the communication techniques can include more or fewer bits, subfields or fields. Alternatively or additionally, the position of information in these packets or frames can be changed. Thus, the order of the subfields or fields can be changed.

While the preceding embodiments illustrate embodiments of the communication techniques using frequency sub-bands, in other embodiments the communication techniques can involve the concurrent use of different temporal slots, and/or or a combination of different frequency sub-bands, different frequency bands and/or different temporal slots. In some embodiments, the communication techniques can use OFDMA.

Moreover, while the preceding embodiments illustrated the use of Wi-Fi during the communication techniques, in other embodiments of the communication techniques Bluetooth or Bluetooth Low Energy is used to communicate at least a portion of the information in the communication techniques. Furthermore, the information communicated in the communication techniques can be communicated or can occur in one or more frequency bands, including: 900 MHz, a 2.4 GHz frequency band, a 5 GHz frequency band, a 6 GHz frequency band, a 60 GHz frequency band, a Citizens Broadband Radio Service (CBRS) frequency band, a band of frequencies used by LTE or another data communication protocol, etc.

As described herein, aspects of the present technology can include the gathering and use of data available from various sources, e.g., to improve or enhance functionality. The present disclosure contemplates that in some instances, this gathered data can include personal information data that uniquely identifies or can be used to contact or locate a specific person. Such personal information data can include demographic data, location-based data, telephone numbers, email addresses, Twitter ID's, home addresses, data or records relating to a user's health or level of fitness (e.g., vital signs measurements, medication information, exercise information), date of birth, or any other identifying or personal information. The present disclosure recognizes that the use of such personal information data, in the present technology, can be used to the benefit of users.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should only occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of, or access to, certain health data can be governed by federal and/or state laws, such as the Health Insurance Portability and Accountability Act (HIPAA); whereas health data in other countries can be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configurable to allow users to selectively “opt in” or “opt out” of participation in the collection of personal information data, e.g., during registration for services or anytime thereafter. In addition to providing “opt in” and “opt out” options, the present disclosure contemplates providing notifications relating to the access or use of personal information. For instance, a user can be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification can be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure can broadly cover use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

We now describe embodiments of an electronic device. FIG. 11 presents a block diagram of an electronic device 1100 (which can be a cellular telephone, a smartwatch, an access point, a wireless speaker, an IoT device, another electronic device, etc.) in accordance with some embodiments. This electronic device includes processing subsystem 1110, memory subsystem 1112 and networking subsystem 1114. Processing subsystem 1110 includes one or more devices configured to perform computational operations. For example, processing subsystem 1110 can include one or more microprocessors, application-specific integrated circuits (ASICs), microcontrollers, graphics processing units (GPUs), programmable-logic devices, and/or one or more digital signal processors (DSPs).

Memory subsystem 1112 includes one or more devices for storing data and/or instructions for processing subsystem 1110, and/or networking subsystem 1114. For example, memory subsystem 1112 can include dynamic random access memory (DRAM), static random access memory (SRAM), a read-only memory (ROM), flash memory, and/or other types of memory. In some embodiments, instructions for processing subsystem 1110 in memory subsystem 1112 include: program instructions or sets of instructions (such as program instructions 1122 or operating system 1124), which can be executed by processing subsystem 1110. For example, a ROM can store programs, utilities or processes to be executed in a non-volatile manner, and DRAM can provide volatile data storage, and can store instructions related to the operation of electronic device 1100. Note that the one or more computer programs can constitute a computer-program mechanism, a computer-readable storage medium or software. Moreover, instructions in the various modules in memory subsystem 1112 can be implemented in: a high-level procedural language, an object-oriented programming language, and/or in an assembly or machine language. Furthermore, the programming language can be compiled or interpreted, e.g., configurable or configured (which can be used interchangeably in this discussion), to be executed by processing subsystem 1110. In some embodiments, the one or more computer programs are distributed over a network-coupled computer system so that the one or more computer programs are stored and executed in a distributed manner.

In addition, memory subsystem 1112 can include mechanisms for controlling access to the memory. In some embodiments, memory subsystem 1112 includes a memory hierarchy that includes one or more caches coupled to a memory in electronic device 1100. In some of these embodiments, one or more of the caches is located in processing subsystem 1110.

In some embodiments, memory subsystem 1112 is coupled to one or more high-capacity mass-storage devices (not shown). For example, memory subsystem 1112 can be coupled to a magnetic or optical drive, a solid-state drive, or another type of mass-storage device. In these embodiments, memory subsystem 1112 can be used by electronic device 1100 as fast-access storage for often-used data, while the mass-storage device is used to store less frequently used data.

Networking subsystem 1114 includes one or more devices configured to couple to and communicate on a wired and/or wireless network (i.e., to perform network operations), such as: control logic 1116, one or more interface circuits (or interface circuitry) 1118 and a set of antennas 1120 (or antenna elements) in an adaptive array that can be selectively turned on and/or off by control logic 1116 to create a variety of optional antenna patterns or ‘beam patterns.’ Alternatively, instead of the set of antennas, in some embodiments electronic device 1100 includes one or more nodes 1108, e.g., a pad or a connector, which can be coupled to the set of antennas 1120. Thus, electronic device 1100 may or may not include the set of antennas 1120. For example, networking subsystem 1114 can include a Bluetooth^{TM} networking system, a cellular networking system (e.g., a 3G/4G/5G network such as UMTS, LTE, etc.), a universal serial bus (USB) networking system, a networking system based on the standards described in IEEE 802.12 (e.g., a Wi-Fi® networking system), an Ethernet networking system, and/or another networking system.

In some embodiments, networking subsystem 1114 includes one or more radios, such as a wake-up radio that is used to receive wake-up frames and wake-up beacons, and a main radio that is used to transmit and/or receive frames or packets during a normal operation mode. The wake-up radio and the main radio can be implemented separately (such as using discrete components or separate integrated circuits) or in a common integrated circuit.

Networking subsystem 1114 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between the electronic devices does not yet exist. Therefore, electronic device 1100 can use the mechanisms in networking subsystem 1114 for performing simple wireless communication between the electronic devices, e.g., transmitting advertising or frame frames and/or scanning for advertising frames transmitted by other electronic devices.

Within electronic device 1100, processing subsystem 1110, memory subsystem 1112 and networking subsystem 1114 are coupled together using bus 1128 that facilitates data transfer between these components. Bus 1128 can include an electrical, optical, and/or electro-optical connection that the subsystems can use to communicate commands and data among one another. Although only one bus 1128 is shown for clarity, different embodiments can include a different number or configuration of electrical, optical, and/or electro-optical connections among the subsystems.

In some embodiments, electronic device 1100 includes a display subsystem 1126 for displaying information on a display, which can include a display driver and the display, such as a liquid-crystal display, a multi-touch touchscreen, etc. Display subsystem 1126 can be controlled by processing subsystem 1110 to display information to a user (e.g., information relating to incoming, outgoing, or an active communication session).

Moreover, electronic device 1100 can also include a user-input subsystem 1130 that allows a user of the electronic device 1100 to interact with electronic device 1100. For example, user-input subsystem 1130 can take a variety of forms, such as: a button, keypad, dial, touch screen, audio input interface, visual/image capture input interface, input in the form of sensor data, etc.

Electronic device 1100 can be (or can be included in) any electronic device with at least one network interface. For example, electronic device 1100 can include: a cellular telephone or a smartphone, a tablet computer, a laptop computer, a notebook computer, a personal or desktop computer, a netbook computer, a media player device, a wireless speaker, an IoT device, an electronic book device, a MiFi® device, a smartwatch, a wearable computing device, a portable computing device, a consumer-electronic device, a vehicle, a door, a window, a portal, an access point, a router, a switch, communication equipment, test equipment, as well as any other type of electronic computing device having wireless communication capability that can include communication via one or more wireless communication protocols.

Although specific components are used to describe electronic device 1100, in alternative embodiments, different components and/or subsystems can be present in electronic device 1100. For example, electronic device 1100 can include one or more additional processing subsystems, memory subsystems, networking subsystems, and/or display subsystems. Additionally, one or more of the subsystems may not be present in electronic device 1100. Moreover, in some embodiments, electronic device 1100 can include one or more additional subsystems that are not shown in FIG. 11. In some embodiments, electronic device 1100 can include an analysis subsystem that performs at least some of the operations in the communication techniques. Also, although separate subsystems are shown in FIG. 11, in some embodiments some or all of a given subsystem or component can be integrated into one or more of the other subsystems or component(s) in electronic device 1100. For example, in some embodiments program instructions 1122 are included in operating system 1124 and/or control logic 1116 is included in the one or more interface circuits 1118.

Moreover, the circuits and components in electronic device 1100 can be implemented using any combination of analog and/or digital circuitry, including: bipolar, PMOS and/or NMOS gates or transistors. Furthermore, signals in these embodiments can include digital signals that have approximately discrete values and/or analog signals that have continuous values. Additionally, components and circuits can be single-ended or differential, and power supplies can be unipolar or bipolar.

An integrated circuit can implement some or all of the functionality of networking subsystem 1114. This integrated circuit can include hardware and/or software mechanisms that are used for transmitting wireless signals from electronic device 1100 and receiving signals at electronic device 1100 from other electronic devices. Aside from the mechanisms herein described, radios are generally known in the art and hence are not described in detail. In general, networking subsystem 1114 and/or the integrated circuit can include any number of radios. Note that the radios in multiple-radio embodiments function in a similar way to the described single-radio embodiments.

In some embodiments, networking subsystem 1114 and/or the integrated circuit include a configuration mechanism (such as one or more hardware and/or software mechanisms) that configures the radio(s) to transmit and/or receive on a given communication channel (e.g., a given carrier frequency). For example, in some embodiments, the configuration mechanism can be used to switch the radio from monitoring and/or transmitting on a given communication channel to monitoring and/or transmitting on a different communication channel. (Note that ‘monitoring’ as used herein includes receiving signals from other electronic devices and possibly performing one or more processing operations on the received signals).

In some embodiments, an output of a process for designing the integrated circuit, or a portion of the integrated circuit, which includes one or more of the circuits described herein can be a computer-readable medium such as, for example, a magnetic tape or an optical or magnetic disk. The computer-readable medium can be encoded with data structures or other information describing circuitry that can be physically instantiated as the integrated circuit or the portion of the integrated circuit. Although various formats can be used for such encoding, these data structures are commonly written in: Caltech Intermediate Format (CIF), Calma GDS II Stream Format (GDSII), Electronic Design Interchange Format (EDIF), OpenAccess (OA), or Open Artwork System Interchange Standard (OASIS). Those of skill in the art of integrated circuit design can develop such data structures from schematic diagrams of the type detailed above and the corresponding descriptions and encode the data structures on the computer-readable medium. Those of skill in the art of integrated circuit fabrication can use such encoded data to fabricate integrated circuits that include one or more of the circuits described herein.

While the preceding discussion used a Wi-Fi communication protocol as an illustrative example, in other embodiments a wide variety of communication protocols and, more generally, wireless communication techniques can be used. Thus, the communication techniques can be used in a variety of network interfaces. Furthermore, while some of the operations in the preceding embodiments were implemented in hardware or software, in general the operations in the preceding embodiments can be implemented in a wide variety of configurations and architectures. Therefore, some or all of the operations in the preceding embodiments can be performed in hardware, in software or both. For example, at least some of the operations in the communication techniques can be implemented using program instructions 1122, operating system 1124 (such as a driver for an interface circuit in networking subsystem 1114) or in firmware in an interface circuit networking subsystem 1114. Alternatively or additionally, at least some of the operations in the communication techniques can be implemented in a physical layer, such as hardware in an interface circuit or interface circuitry in networking subsystem 1114. In some embodiments, the communication techniques are implemented, at least in part, in a MAC layer and/or in a physical layer in an interface circuit in networking subsystem 1114.

Note that the use of the phrases ‘capable of,’ ‘capable to,’ ‘operable to,’ or ‘configured to’ in one or more embodiments, refers to some apparatus, logic, hardware, and/or element designed in such a way to enable use of the apparatus, logic, hardware, and/or element in a specified manner.

While examples of numerical values are provided in the preceding discussion, in other embodiments different numerical values are used. Consequently, the numerical values provided are not intended to be limiting.

Moreover, while the preceding embodiments illustrated the use of wireless signals in one or more bands of frequencies, in other embodiments of the communication techniques electromagnetic signals in one or more different frequency bands are used. For example, these signals can be communicated in one or more bands of frequencies, including: a microwave frequency band, a radar frequency band, 900 MHz, 2.4 GHz, 5 GHz, 6 GHz, 60 GHz, and/or a band of frequencies used by a Citizens Broadband Radio Service or by LTE.

In the preceding description, we refer to ‘some embodiments.’ Note that ‘some embodiments’ describes a subset of all of the possible embodiments, but does not always specify the same subset of embodiments.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein can be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. An electronic device, comprising:
an antenna node configured to communicatively couple to an antenna; and
an interface circuit, communicatively coupled to the antenna node, configured to communicate with a second electronic device, wherein the interface circuit is configured to:
generate, addressed to the second electronic device, a block acknowledgment request (BAR) frame configured as an initial control frame (ICF), wherein the BAR frame comprises at least one of:
padding for enhanced multi-link single radio (eMLSR) operation;
a length or duration of an immediate control response (ICR) to the BAR frame; or
an indication of recommended feedback associated with the BAR frame.

2. The electronic device of claim 1, wherein the interface circuit is configured to receive, associated with the second electronic device, a multi-station block acknowledgment (BA) in response to the BAR frame.

3. The electronic device of claim 1, wherein the BAR frame comprises a single-user multi-traffic identifier (TID) BAR.

4. The electronic device of claim 1, wherein the BAR frame comprises a compressed BAR frame that specifies a traffic identifier (TID).

5. The electronic device of claim 1, wherein a BAR control field in the BAR frame comprises:
an indication of whether the BAR frame is integrity protected; an indication of whether the BAR frame comprises the ICF; an indication of whether the second electronic device is to perform a carrier sense operation before providing the ICR; or an indication of whether the BAR frame comprises second feedback to the second electronic device.

6. The electronic device of claim 5, wherein, when the indication of whether the BAR frame comprises the ICF indicates that the BAR frame does comprise the ICF, the ICR in response to the BAR frame comprises a multi-station block acknowledgment (BA).

7. The electronic device of claim 5, wherein the indication of whether the second electronic device is to perform a carrier sense operation before providing the ICR, the indication of whether the BAR frame comprises the second feedback to the second electronic device, or both, is valid when the BAR frame comprises the ICF.

8. The electronic device of claim 1, wherein a BAR information field in the BAR frame comprises a bitmap that indicates second feedback is included in the BAR frame.

9. The electronic device of claim 1, wherein the BAR frame comprises: an unavailability profile of the electronic device; or a power save attribute of the electronic device.

10. The electronic device of claim 1, wherein the BAR frame comprises: a packet number (PN) and a message integrity code (MIC) when the BAR frame is integrity protected; or a pre-padding frame check sequence (FCS) when the BAR frame is not integrity protected.

11. The electronic device of claim 1, wherein a BAR control field in the BAR frame comprises multiple traffic identifiers (TIDs).

12. The electronic device of claim 1, wherein the ICR in response to the BAR frame is always a multi-station block acknowledgment (BA).

13. A method for generating a block acknowledgment request (BAR) frame, comprising:
by an electronic device:
generating, addressed to a second electronic device, a block acknowledgment request (BAR) frame configured as an initial control frame (ICF), wherein the BAR frame comprises at least one of:
padding for enhanced multi-link single radio (eMLSR) operation;
a length or duration of an immediate control response (ICR) to the BAR frame; or
an indication of recommended feedback associated with the BAR frame; and
receiving, associated with the second electronic device, a multi-station block acknowledgment (BA) in response to the BAR frame.

14. The method of claim 13, wherein the BAR frame comprises a single-user multi-traffic identifier (TID) BAR or a compressed BAR frame that specifies a TID.

15. The method of claim 13, wherein a BAR control field in the BAR frame comprises: an indication of whether the BAR frame is integrity protected; an indication of whether the BAR frame comprises the ICF; an indication of whether the second electronic device is to perform a carrier sense operation before providing the ICR; or an indication of whether the BAR frame comprises second feedback to the second electronic device.

16. An electronic device, comprising:
an antenna node configured to communicatively couple to an antenna; and
an interface circuit, communicatively coupled to the antenna node, configured to communicate with a second electronic device, wherein the interface circuit is configured to:
receive, associated with the second electronic device, a block acknowledgment request (BAR) frame configured as an initial control frame (ICF), wherein the BAR frame comprises at least one of:
padding for enhanced multi-link single radio (eMLSR) operation;
a length or duration of an immediate control response (ICR) to the BAR frame; or
an indication of recommended feedback associated with the BAR frame.

17. The second electronic device of claim 16, wherein the interface circuit is configured to provide, addressed to the electronic device, a multi-station block acknowledgment (BA) in response to the BAR frame.

18. The second electronic device of claim 16, wherein the BAR frame comprises a single-user multi-traffic identifier (TID) BAR or a compressed BAR frame that specifies a TID.

19. The second electronic device of claim 16, wherein a BAR control field in the BAR frame comprises: an indication of whether the BAR frame is integrity protected; an indication of whether the BAR frame comprises the ICF; an indication of whether the second electronic device is to perform a carrier sense operation before providing the ICR; or an indication of whether the BAR frame comprises second feedback to the second electronic device.

20. The second electronic device of claim 16, wherein a BAR information field in the BAR frame comprises a bitmap that indicates second feedback is included in the BAR frame.
